(19) United States
(12) Patent Application Publication
(10) Pub. No.: US 2005/0196222 A1
(43) Pub. Date: Sep. 8, 2005

(54) Pen with a sounding generating device

(76) Inventor: Dido Cheng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/790,104

(22) Filed: Mar. 2, 2004

(51) Int. Cl. B43K 25/00

(52) U.S. Cl. 401/195

(57) ABSTRACT

A pen includes a penholder with a tip at one end and a decoration piece on the other end of the penholder. A head is pivotably connected to the decoration piece which has two striking pieces and the head is located between the two striking pieces. The head is a hollow casing with an open top and at least one slot defined through the casing and communicates the open top. A decoration part is connected to the open top of the head which pivots and is hit by the two striking pieces to generate sound when using the pen. A base member has a hole so that the pen is inserted in the hole of the base member.

### FIELD OF THE INVENTION

The present invention relates to a pen having decoration piece on a top thereof and a head is pivotably connected to the decoration piece. The head hits two striking pieces to generate sound when using the pen.

### BACKGROUND OF THE INVENTION

A conventional pen includes a penholder and a tip at an end of the penholder. Users may hold the penholder and write on paper by the tip. This is the only function that a conventional pen has. In order to encourage or attract children to love to drawing or writing, some pens are decorated with feather, colorful indicia, or any attachment that attracts the children. Nevertheless, all of the decorations are stationary and cannot generate sound to provide more fun to the users.

The present invention intends to provide a pen that includes a sound generating device which generates sound together with the swinging of the pen when in use and provides a lot of fun to the users.

### SUMMARY OF THE INVENTION

The present invention relates to a pen which comprises a penholder with a decoration piece connected to the penholder and a head pivotably connected to the decoration piece. A striking part is connected to the decoration piece and at least one striking piece is connected to the striking part. The head pivots and is hit by the at least one striking piece during use of the pen.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the pen and the sound generating device of the present invention;

FIG. 2 is an exploded view to show the pen and the sound generating device of the present invention;

FIG. 3 is a front view to show the pen and the connection of the head and the decoration part;

FIG. 4 shows the head pivots and hit by the two striking pieces;

FIG. 5 shows a different decoration member on the first plate of the connection part, and

FIG. 6 shows that a fragrance part is connected to the penholder.

### DETAILED DESCRIPTION OF THE PREFERRED EMBODIMENT

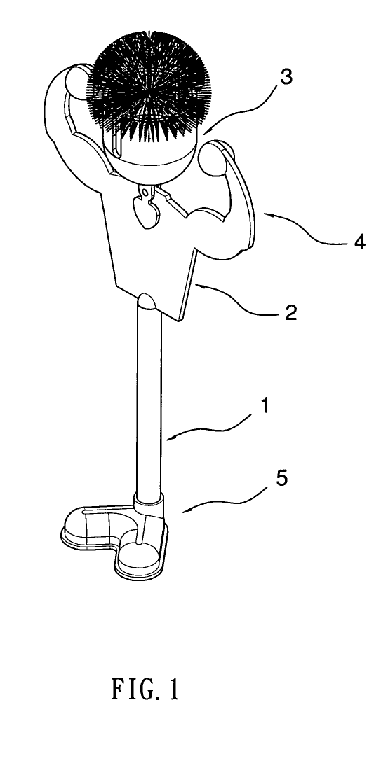

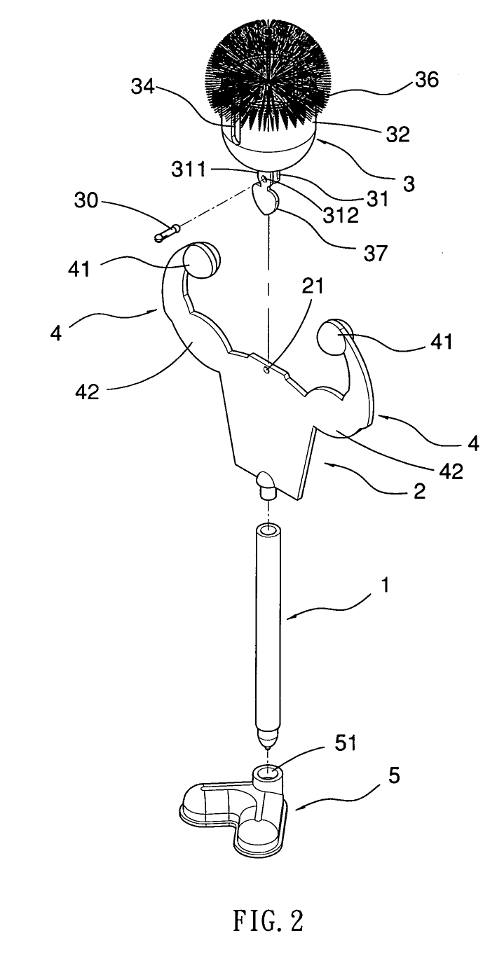

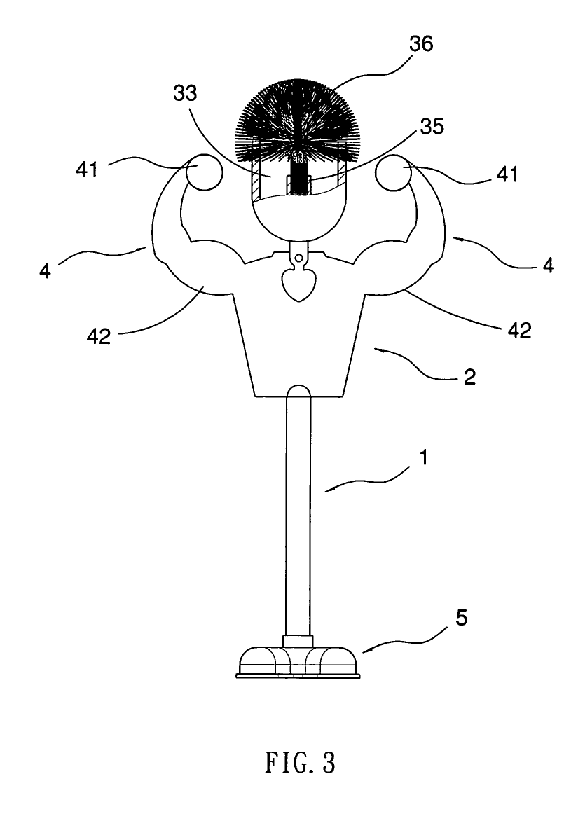

Referring to FIGS. 1 to 3, the pen of the present invention comprises a pen comprises a penholder 1 having a tip at one end and a decoration piece 2 connected to the other end of the penholder 1. A head 3 is pivotably connected to the decoration piece 2. The decoration piece 2 is made to be a shape of human body and a striking part 4 is connected to the decoration piece 2. The striking part 4 includes two arms 42 extending from two sides thereof and each arm 42 has a striking piece 41 connected to a distal end thereof. The head 3 is located between the two striking pieces 41 and each striking piece 41 is in a shape of a ball.

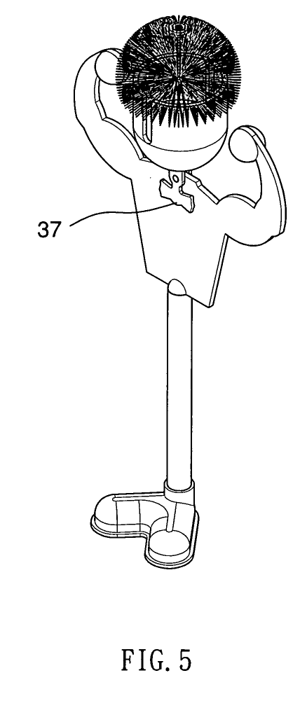

The head 3 includes a connection part at a lower end thereof and the connection part includes a first plate 31 and a second plate 311. Two aligned first holes 312 are defined through the first plate 31 and the second plate 311 of the connection part respectively. A second hole 21 is defined through the decoration piece 2 and a pin 30 extend through the first holes 312 and the second hole 21 so that the head 3 is pivotably connected to the decoration piece 2. The head 3 is a hollow casing 32 which has an open top 33 and at least one slot 34 is defined through a wall of the casing 32 and communicates the open top 33. A receiving member 35 is located inside of the head 3 and a decoration part 36 is connected to the receiving member 35. The decoration part 36 which is made as hair of a human and engaged with the open top 33 of the head 3. A decoration member 37 is connected to a lower end of the first plate 311. The decoration member 37 may be made to be any other form such as a bow tie as shown in FIG. 5. A base member 5 which is made as two feet of human includes a hole 51 and the pen is inserted in the hole 51.

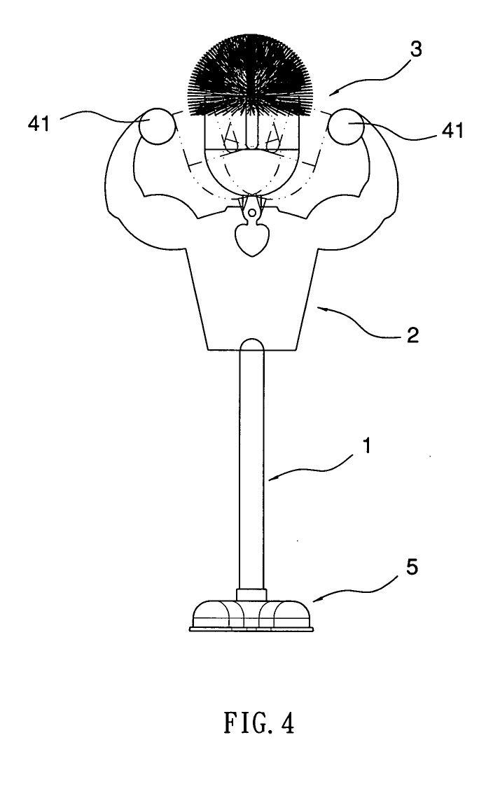

As shown in FIG. 4, when using or shaking the pen, the striking pieces 41 hit the head 3 when the head pivots and generate sound.

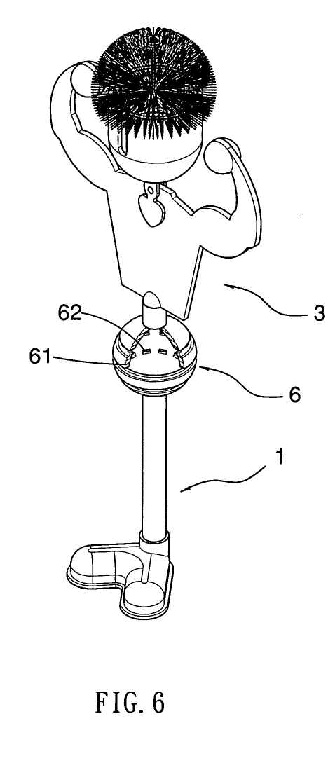

Referring to FIG. 6, a fragrance part 6 is connected to the penholder 1 and includes a box 61 in which fragrance material is received and a plurality of dispensing holes 62 are defined through a wall of the box 61 of the fragrance part 6 so that the fragrance dispenses from the dispensing holes 62.

While we have shown and described the embodiment in accordance with the present invention, it should be clear to those skilled in the art that further embodiments may be made without departing from the scope of the present invention.

1. A pen comprising:
a penholder;
a decoration piece connected to the penholder;
a head pivotably connected to the decoration piece, and
a striking part connected to the decoration piece and at least one striking piece connected to the striking part, the at least one striking piece being located to hit the head when the head pivots.

2. The pen as claimed in claim 1, wherein the striking part includes at least one arm extending therefrom and the at least one striking piece is connected to a distal end of the at least one arm.

3. The pen as claimed in claim 2, wherein the at least one striking piece is a ball-shape piece.

4. The pen as claimed in claim 1, wherein the head includes a hollow casing having an open top and at least one slot is defined through a wall of the casing and communicates the open top.

5. The pen as claimed in claim 4 further comprising a decoration part which is engaged with the open top of the head.

6. The pen as claimed in claim 5 further comprising a receiving member located inside of the head and the decoration part connected to the receiving member.

7. The pen as claimed in claim 1, wherein the head includes a connection part which includes a first plate and a second plate, two first holes defined through the first plate and the second plate of the connection part, a second hole defined through the decoration piece and a pin extending through the first holes and the second hole.

8. The pen as claimed in claim 7, wherein a decoration member is connected to the first plate.

9. The pen as claimed in claim 1 further comprising a fragrance part connected to the penholder.

10. The pen as claimed in claim 9, wherein the fragrance part includes a box and a plurality of dispensing holes are defined through a wall of the box of the fragrance part.

11. The pen as claimed in claim 1 further comprising a base member which includes a hole and the pen is inserted in the hole.
